(19) United States
(12) Patent Application Publication
(10) Pub. No.: US 2025/0015423 A1
(43) Pub. Date: Jan. 9, 2025

(54) BATTERY CELL PRESSURE CONTROL

(71) Applicant: GM GLOBAL TECHNOLOGY OPERATIONS LLC, DETROIT, MI (US)

(72) Inventors: Yongjie Zhu, Troy, MI (US); Meng Jiang, Rochester Hills, MI (US); Chunhao J. Lee, Troy, MI (US); Chen-fang Chang, Bloomfield Hills, MI (US); Insu Chang, Troy, MI (US); Jun-mo Kang, Ann Arbor, MI (US)

(21) Appl. No.: 18/347,990

(22) Filed: Jul. 6, 2023

(51) Int. Cl. H01M 50/317; H01M 50/202; H01M 50/249

(52) U.S. Cl. CPC H01M 50/317; H01M 50/202; H01M 50/249; H01M 2220/20

(57) ABSTRACT

A pressure control apparatus for a battery cell includes a housing in which the battery cell is positioned, and a cell plate movably positioned in the housing and separating an interior of the housing into a cell chamber having the battery cell therein, and a pressure chamber having a volume of pressurized fluid therein. The apparatus further includes a valve configured to allow a portion of the pressurized fluid to be removed from the pressure chamber when the pressure in the pressure chamber exceeds a threshold.

### INTRODUCTION

The subject disclosure relates to rechargeable energy storage devices for, for example, electrically powered vehicles.

Rechargeable energy storage devices, such as lithium metal battery cells, are typically restricted to a fixed volume, applying an initial external pressure to the battery structure. This initial pressure aids in preventing the growth of lithium dendrites. During cycling of the battery, however, the internal cell pressure continually increases and after many cycles may lead to performance degradation.

It is desirable to provide a battery fixture to prevent dendrite formation, while also preventing separator breakage.

### SUMMARY

In one exemplary embodiment, a pressure control apparatus for a battery cell includes a housing in which the battery cell is positioned, and a cell plate movably positioned in the housing and separating an interior of the housing into a cell chamber having the battery cell therein, and a pressure chamber having a volume of pressurized fluid therein. The apparatus further includes a valve configured to allow a portion of the pressurized fluid to be removed from the pressure chamber when the pressure in the pressure chamber exceeds a threshold.

In addition to one or more of the features described herein, a fluid pump is operably connected to the pressure chamber to pressurize the pressure chamber with fluid.

In addition to one or more of the features described herein, the valve is a passive check valve.

In addition to one or more of the features described herein, one or more pressure sensors are located in the pressure chamber, the valve is operated in response to a pressure exceeding the threshold detected by the one or more pressure sensors.

In addition to one or more of the features described herein, a secondary pressure chamber is located in the housing, and the valve controls the flow of fluid between the pressure chamber and the secondary pressure chamber.

In addition to one or more of the features described herein, the valve is a solenoid-actuated valve.

In addition to one or more of the features described herein, the pressure in the pressure chamber increases in response to an increase in size of the battery cell.

In another exemplary embodiment, a battery cell assembly of a vehicle includes a housing located at the vehicle, and a battery cell positioned in the housing. The battery cell includes a cathode, an anode, and a separator positioned between the cathode and the anode. A pressure control apparatus is operably connected to the battery cell and includes a cell plate movably positioned in the housing and separating an interior of the housing into a cell chamber having the battery cell therein, and a pressure chamber having a volume of pressurized fluid therein. A valve is configured to allow a portion of the pressurized fluid to be removed from the pressure chamber when the pressure in the pressure chamber exceeds a threshold.

In addition to one or more of the features described herein, a fluid pump is operably connected to the pressure chamber to pressurize the pressure chamber with fluid.

In addition to one or more of the features described herein, the valve is a passive check valve.

In addition to one or more of the features described herein, one or more pressure sensors are positioned in the pressure chamber, and the valve is operated in response to a pressure exceeding the threshold detected by the one or more pressure sensors.

In addition to one or more of the features described herein, a secondary pressure chamber is positioned in the housing, and the valve controls the flow of fluid between the pressure chamber and the secondary pressure chamber.

In addition to one or more of the features described herein, the valve is a solenoid-actuated valve.

In addition to one or more of the features described herein, the pressure in the pressure chamber increases in response to an increase in size of the battery cell.

In addition to one or more of the features described herein, the battery cell is a lithium metal battery cell.

In yet another exemplary embodiment, a method of regulating external pressure on a battery cell of a vehicle includes positioning the battery cell in a housing located at the vehicle, the housing defining a cell chamber in which the battery cell is located and a pressure chamber including a volume of pressurized fluid therein. The method further includes increasing a volume of the battery cell via cycling of the battery cell, and reducing a volume of fluid in the pressure chamber when the fluid pressure exceeds a threshold in response to the increase in volume of the battery cell, thereby reducing an external pressure on the battery cell.

In addition to one or more of the features described herein, the fluid pressure in the pressure chamber is measured via one or more pressure sensors located in the pressure chamber, and a valve is operated in response to the measured pressure exceeding a threshold to reduce the volume of fluid in the pressure chamber.

In addition to one or more of the features described herein, reducing the volume of fluid in the pressure chamber includes moving a portion of the volume of fluid to a secondary chamber positioned in the housing.

In addition to one or more of the features described herein, the method includes operating a pump operably connected to the pressure chamber to pressurize the volume of fluid to an initial pressure.

In addition to one or more of the features described herein, reducing the volume of fluid includes passively operating a check valve located at the pressure chamber when the fluid pressure exceeds the threshold.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a schematic illustration of a vehicle;

FIG. 2 is a schematic illustration of an embodiment of a pressure control apparatus of a battery cell;

FIG. 3 is a cross-sectional view of an embodiment of a check valve;

FIG. 4 is a schematic illustration of another embodiment of a pressure control apparatus of a battery cell;

FIG. 5 is a schematic illustration of yet another embodiment of a pressure control apparatus of a battery cell; and

FIG. 6 is a schematic illustration of another embodiment of a pressure control apparatus of a battery cell.

### DETAILED DESCRIPTION

The following description is merely exemplary in nature and is not intended to limit the present disclosure, its application or uses. It should be understood that throughout the drawings, corresponding reference numerals indicate like or corresponding parts and features.

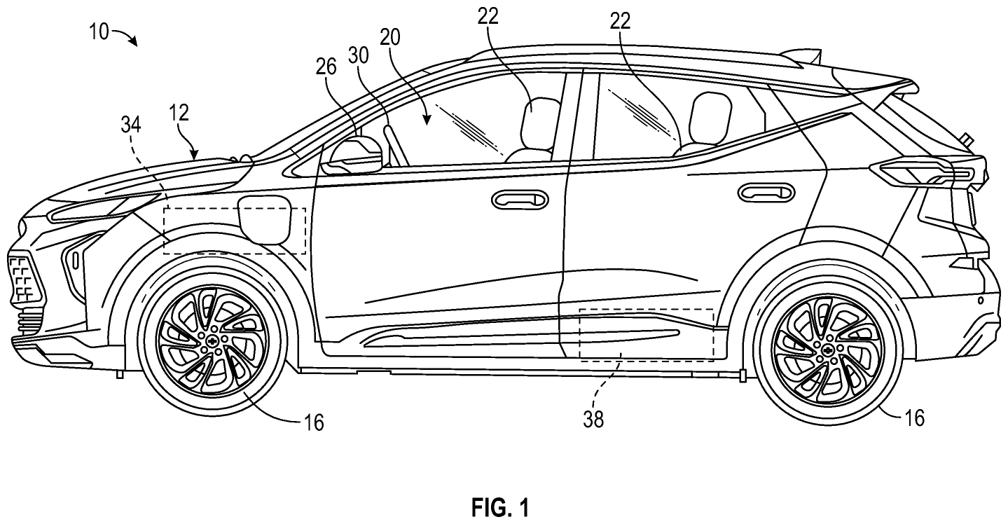

In accordance with an exemplary embodiment a vehicle, in accordance with a non-limiting example, is indicated generally at 10 in FIG. 1. Vehicle 10 includes a body 12 supported on a plurality of wheels 16. In a non-limiting example, two of the plurality of wheels 16 are steerable. Body 12 defines, in part, a passenger compartment 20 having seats 22 positioned behind a dashboard 26. A steering control 30 is arranged between seats 22 and dashboard 26. Steering control 30 is operated to control orientation of the steerable wheel(s). Vehicle 10 includes an electric motor 34 connected to a transmission that provides power to one or more of the plurality of wheels 16. A rechargeable energy storage system (RESS) 38 or battery assembly provides power to electric motor 34.

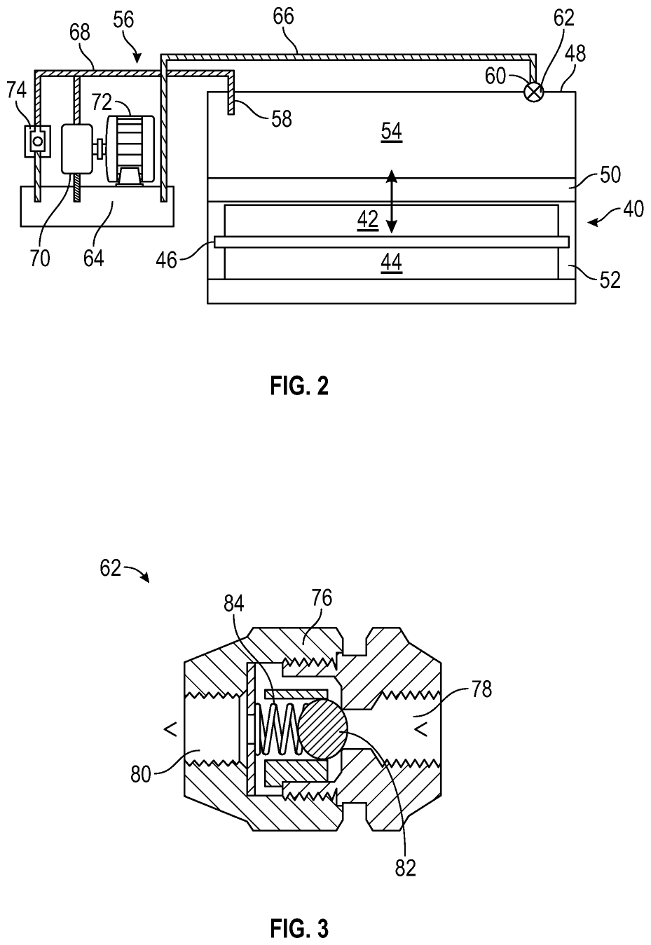

The RESS 38 may include one or more battery cells 40, an exemplary embodiment of which is illustrated in FIG. 2. In some embodiments, the battery cell 40 is a lithium metal battery cell. The battery cell 40 includes a cathode 42 and an anode 44 with a separator 46 disposed therebetween. The battery cell 40 is disposed in a housing 48 and includes a cell plate 50 in the housing 48 extending across the battery cell 40. The cell plate 50 is movable in the housing 48 and divides the interior of the housing 48 into a cell chamber 52 in which the cathode 42, anode 44 and separator 46 are disposed, and a pressure chamber 54. The pressure chamber 54 is part of a fluid circuit 56, in which a volume of compressed liquid, such as a hydraulic fluid, is disposed to maintain an internal pressure of the pressure chamber 54 at or below a preselected threshold. Maintaining the selected pressure in the pressure chamber 54 keeps a desired external pressure on the battery cell 40.

The pressure chamber 54 includes a fluid inlet 58 and a fluid outlet 60, with a check valve 62 connected to the fluid outlet 60 such that when the fluid pressure in the pressure chamber 54 exceeds the preselected threshold, due to for example increase in volume of the battery cell 40 due to cycling of the battery cell 40, the check valve 62 automatically opens and allows excess fluid to exit the pressure chamber 54 through the fluid outlet 60 until the fluid pressure is lowered below the threshold. The excess fluid is directed to a fluid reservoir 64 via an outlet pathway 66.

In some embodiments the check valve 62 is disposed at the fluid outlet 60, while in other embodiments the check valve 62 may be located along the outlet pathway 66. The fluid reservoir 64 is connected to the fluid inlet 58 via an inlet pathway 68, and a pump 70 is located along the inlet pathway 68 to, when activated, urge the fluid from the fluid reservoir 64 into the pressure chamber 54 to pressurize the pressure chamber 54. The pump 70 may be driven by a motor 72, and in some embodiments a relief valve 74 is located along the inlet pathway 68.

Referring now to FIG. 3, illustrated is an embodiment of a check valve 62. The check valve 62 includes a valve body 76 having a valve inlet 78 and a valve outlet 80. A valve element 82, such as a ball, is disposed in the valve body 76 and is biased into a closed position by, for example, a spring 84 such that the valve element 82 blocks fluid from passing through the valve body 76. When the fluid pressure in the pressure chamber 54 (as in FIG. 2) exceeds the threshold, the biasing force of the spring 84 is overcome, and the valve element 82 moves to an open position allowing the fluid to pass through the check valve 62 toward the fluid reservoir 64 (illustrated in FIG. 2). When the pressure in the pressure chamber 54 is reduced below the threshold, the biasing force is greater than the fluid pressure and the valve element 82 returns to the closed position. One skilled in the art will readily appreciate that by changing the biasing force by, for example, changing the spring 84, different thresholds may be utilized.

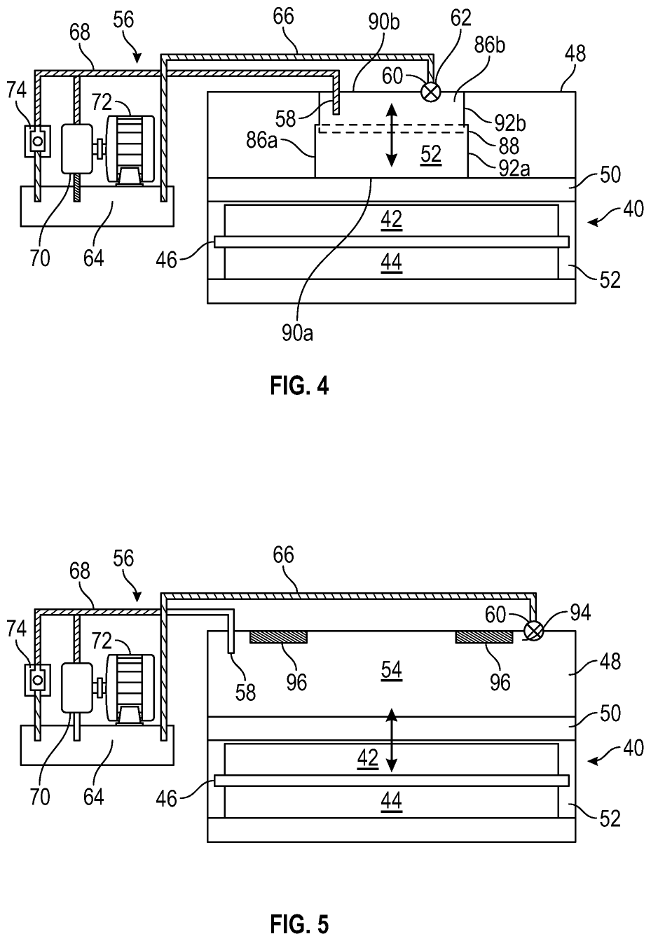

Referring now to FIG. 4, another embodiment is illustrated in which the pressure chamber 54 is defined by two overlapping chamber portions 86a and 86b having a seal element 88 therebetween to seal the pressure chamber 54. Each chamber portion 86a, 86b has a chamber base 90a and 90b and a chamber wall 92a and 92b extending from the chamber base 90a and 90b. The chamber base 90a of the first chamber portion 86a is secured to the cell plate 50 and is movable therewith as the battery cell 40 changes in volume. The second chamber portion 86b is secured to the housing 48 with the chamber wall 92b of the second chamber portion 86b extending toward the chamber base 90a of the first chamber portion 86a. Similarly, the chamber wall 92a of the first chamber portion 86a extends toward the chamber base 90b of the second chamber portion 86b such that the chamber walls 92a and 92b overlap to define the pressure chamber 54. In some embodiments the pressure chamber 54 may have a circular cross-section, while one skilled in the art will readily appreciate that other cross-sectional shapes such as oval, rectangular or rounded rectangular may be utilized. The pressure chamber 54 configuration of FIG. 4 reduces the volume of fluid required to generate the selected pressure in the pressure chamber 54 and the smaller volume of fluid is easier to control the pressure of, as compared to a larger volume.

In another embodiment, illustrated in FIG. 5, fluid pressure in the pressure chamber 54 is controlled by one or more electronically-controlled valves 94 that are operably connected to one or more pressure sensors 96. The pressure sensors 96 are disposed in the pressure chamber 54 and detect the fluid pressure in the pressure chamber 54. When the detected pressure exceeds the threshold, the electronically-controlled valves 94 are commanded to open, to allow fluid to flow from the pressure chamber 54 to the fluid reservoir 64.

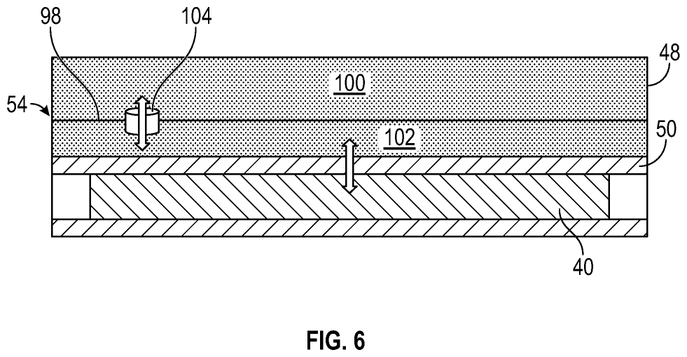

Another embodiment is illustrated in FIG. 6, the pressure chamber 54 in the housing 48 includes a fixed chamber separator wall 98, dividing the pressure chamber 54 into a primary chamber 102 and a secondary chamber 100. A valve 104, in some embodiments operated via a solenoid actuator, selectably allows the flow of fluid between the secondary chamber 100 and the primary chamber 102. As fluid pressure in the primary chamber 102 increases, for example, the valve 104 may be opened to pass fluid to the secondary chamber 100. Similarly, when the fluid pressure in the primary chamber 102 reduces, the valve 104 may be opened to allow fluid to flow from the secondary chamber 100 to the primary chamber 102.

Use of the configurations herein allow for regulating the battery cell 40 operating pressure via a hydraulic fluid device, either passively via for, example, a check valve, or actively. This reduces the incidence of separator failure in the batter cell 40.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A pressure control apparatus for a battery cell, comprising:
a housing in which the battery cell is disposed;
a cell plate movably disposed in the housing and separating an interior of the housing into:
a cell chamber having the battery cell therein; and
a pressure chamber having a volume of pressurized fluid therein; and
a valve configured to allow a portion of the pressurized fluid to be removed from the pressure chamber when the pressure in the pressure chamber exceeds a threshold.

2. The pressure control apparatus of claim 1, further comprising a fluid pump operably connected to the pressure chamber to pressurize the pressure chamber with fluid.

3. The pressure control apparatus of claim 1, wherein the valve is a passive check valve.

4. The pressure control apparatus of claim 1, further comprising one or more pressure sensors disposed in the pressure chamber wherein the valve is operated in response to a pressure exceeding the threshold detected by the one or more pressure sensors.

5. The pressure control apparatus of claim 1, further comprising a secondary pressure chamber disposed in the housing wherein the valve controls a flow of fluid between the pressure chamber and the secondary pressure chamber.

6. The pressure control apparatus of claim 5, wherein the valve is a solenoid-actuated valve.

7. The pressure control apparatus of claim 1, wherein the pressure in the pressure chamber increases in response to an increase in size of the battery cell.

8. A battery cell assembly of a vehicle, comprising:
a housing disposed in the vehicle:
a battery cell disposed in the housing, including:
a cathode;
an anode; and
a separator disposed between the cathode and the anode; and
a pressure control apparatus operably connected to the battery cell, including:
a cell plate movably disposed in the housing and separating an interior of the housing into:
a cell chamber having the battery cell therein; and
a pressure chamber having a volume of pressurized fluid therein; and
a valve configured to allow a portion of the pressurized fluid to be removed from the pressure chamber when a pressure in the pressure chamber exceeds a threshold.

9. The battery cell assembly of claim 8, further comprising a fluid pump operably connected to the pressure chamber to pressurize the pressure chamber with fluid.

10. The battery cell assembly of claim 8, wherein the valve is a passive check valve.

11. The battery cell assembly of claim 8, further comprising one or more pressure sensors disposed in the pressure chamber wherein the valve is operated in response to a pressure exceeding the threshold detected by the one or more pressure sensors.

12. The battery cell assembly of claim 8, further comprising a secondary pressure chamber disposed in the housing wherein the valve controls the flow of fluid between the pressure chamber and the secondary pressure chamber.

13. The battery cell assembly of claim 12, wherein the valve is a solenoid-actuated valve.

14. The battery cell assembly of claim 8, wherein the pressure in the pressure chamber increases in response to an increase in size of the battery cell.

15. The battery cell assembly of claim 8, wherein the battery cell is a lithium metal battery cell.

16. A method of regulating external pressure on a battery cell of a vehicle, comprising:
positioning the battery cell in a housing located at the vehicle, the housing defining:
a cell chamber in which the battery cell is located; and
a pressure chamber including a volume of pressurized fluid therein;
increasing a volume of the battery cell via cycling of the battery cell; and
reducing a volume of fluid in the pressure chamber when the fluid pressure exceeds a threshold in response to the increase in volume of the battery cell, thereby reducing an external pressure on the battery cell.

17. The method of claim 16, further comprising:
measuring the fluid pressure in the pressure chamber via one or more pressure sensors disposed in the pressure chamber; and
operating a valve in response to a measured pressure exceeding a threshold to reduce the volume of fluid in the pressure chamber.

18. The method of claim 16, wherein reducing the volume of fluid in the pressure chamber comprises moving a portion of the volume of fluid to a secondary chamber disposed in the housing.

19. The method of claim 16, further comprising operating a pump operably connected to the pressure chamber to pressurize the volume of fluid to an initial pressure.

20. The method of claim 16, wherein reducing the volume of fluid comprises passively operating a check valve disposed at the pressure chamber when the fluid pressure exceeds the threshold.
